(19) United States
(12) Patent Application Publication
(10) Pub. No.: US 2016/0092562 A1
(43) Pub. Date: Mar. 31, 2016

(54) APPARATUS AND METHOD FOR ACTIVE ACQUISITION OF KEY INFORMATION AND PROVIDING RELATED INFORMATION

(71) Applicant: Marty McGinley, Overland park, KS (US)

(72) Inventor: Marty McGinley, Overland park, KS (US)

(21) Appl. No.: 14/496,718

(22) Filed: Sep. 25, 2014

(51) Int. Cl. G06F 17/30

(52) U.S. Cl. CPC G06F 17/30864

(57) ABSTRACT

An apparatus for automatically providing information related to actively acquired key information is disclosed. The apparatus 201 comprises an input device 205 to actively acquire key information, an output device 209 to provide the related information, a processor, and a memory. The processor is configured to access an information source 221 to search for related information based on the key information, and to receive the found related information. The information source may be stored in the memory, or remotely, or partly in the memory and partly remotely. The processor may be in the same physical device as the input device and the output device, or the processor may be in a separate physical device from the input and output devices.

### FIELD OF THE INVENTION

The invention relates to apparatuses and methods for the automatic acquisition of key information and the automatic search and provision of information related to the key information.

### BACKGROUND OF THE INVENTION

Obtaining up-to-date information is desirable in many circumstances. A person having the latest relevant information in a conversation with another person can carry on a more effective conversation. A salesperson having up-to-date information related to a customer or a potential customer is able to have a more productive conversation with such customer or potential customer. A person in a conversation with an acquaintance can reconnect more meaningfully with up-to-date information related to the acquaintance. When meeting a stranger, a person having up-to-date information related to the stranger is able to have a more natural conversation.

Unfortunately, up-to-date information is often difficult or impractical to obtain. For example, a person preparing to meet a number of people, as a group or individually one after another, can spend some time gathering the latest information about them. The information may be gathered from resources and databases, such as social media sites, web search engines, commercial databases, customer relationship management databases, and sales information databases. Such a time-consuming process requires even more time in a subsequent step to memorize the information prior to meeting the people. In some cases, the information about those people may have to be gathered far in advance of the meeting, resulting in information that may not be up-to-date. In other cases, up-to-date information cannot be obtained in advance, because a person may not or cannot know the identity the persons that he might meet or unexpectedly encounter.

Up-to-date information can be obtained using known methods or devices. For example, a person, upon meeting another person, may obtain the other person's name and then, during the conversation between them, operate a device, such as a smartphone or laptop, to obtain up-to-date information about the other person. However, operating a device in that way to obtain up-to-date information requires manual operation and is disruptive to the conversation. In another example, upon meeting another person, a person may, during the conversation, operate a visibly obtrusive wearable device, such as the Google Glass™ device, to obtain up-to-date information about the other person by providing instructions to the device, so that the device may then respond by presenting the information visually to the person. Again, operating such device in that manner is disruptive, because it requires manually providing instructions or commands. Thus, obtaining up-to-date information in a less obtrusive, less disruptive, and more automated method is desirable. Obtaining such information using a device that is visibly less obtrusive is also desirable.

Up-to-date information may include information in social media concerning a person. For example, that information may include updates and posts by the person to his social media account, and updates and posts about the person by another person in another social media account. Some examples of social media include websites such as facebook.com, twitter.com, and linkedin.com. Up-to-date information may include information concerning a customer, and may be retrieved from data sources such as the World Wide Web, a sales database, or a contact database. Up-to-date information may also include information concerning a patient, and may be retrieved from data sources, such as a health information systems and patient databases.

### SUMMARY OF THE INVENTION

Broadly, the disclosed systems, methods, and apparatuses enable information to be automatically provided. The disclosed subject matter relates to actively acquiring key information, and automatically providing information related to that key information. The apparatuses are provided with a processor configured to actively acquire the key information via an input device. In some embodiments, more than one processor is provided and configured. The processor is further configured to automatically provide the information related to the key information (the “related information”). The apparatus is provided with one or more memories, and the key information and the related information are stored in the one or more memories. More specifically, key information is actively acquired, and information sources are accessed and searched to retrieve the related information. The related information includes up-to-date information related to the key information. Further, the related information can be automatically provided to a user using the apparatus.

Some embodiments of the invention include an apparatus for providing information related to key information. The apparatus includes a processor, and actively acquires key information. The processor is configured to access an information source to search for information related to the key information (the “related info”). The apparatus includes a memory for storing the key information and the related information. The apparatus may further include an input device for acquiring the key information and an output device for providing the related information. The processor is further configured to receive the key information from the input device, and to provide the related information to the output device.

In some embodiments, the active acquisition means that the key information is continuously, or substantially continuously, acquired. In some other embodiments, active acquisition means acquiring the key information at periodic intervals, including at regular periodic intervals. In yet other embodiments, the apparatus automatically acquires key information when conditions are met, for example, only when the key information (such as sounds) is detected, or only when changes to the key information (such as changing visual information) are detected.

Embodiments of the key information include sounds, electromagnetic radiation, location information, global positioning system (GPS) information, wireless signal information, motion information, ionization radiation, and atmospheric information. Embodiments of the input device for acquiring the key information include a microphone; a camera; a global positioning system (GPS) receiver; a wireless signal receiver; a thermometer; a humidity sensor; and a barometer. Embodiments of the output device for providing related information include a visual display device; a speaker; a visible indicator; and a haptic feedback device. Embodiments of the information source include social media data; web page sources; a sales database; a contact database; a weather information system; a health information system; a patient database; news information data; a geographic information system; a geographical database; and a vehicle repair database.

The information source, in some cases, is stored remotely from the processor, and in other cases is stored in the memory of the apparatus. Moreover, more than one information source can be provided, and in such case, all sources may be stored together either remotely from the processor or in the memory of the apparatus, or some sources may be stored remotely while others are stored in the memory. The processor can further be configured to access each information source to search that source for information related to the key information and to retrieve the related information. The processor is further configured to access a remotely stored information source either via a wired connection or a wireless connection.

In some embodiments, the processor is further configured to prepare the key information for search. Thus, in the case where the key information includes sounds, the processor is configured to prepare the sounds by applying speech recognition to the sounds to process the sounds for subsequent search. And, in the case where the key information includes visual information such as images, the processor is configured to prepare the visual information by applying pattern recognition to process the visual information for subsequent search. In many cases where the key information includes analog information, the processor is configured to prepare the analog information for subsequent search by converting the analog information to digital data.

According to some embodiments, the input device, the output device, the processor, and the memory are contained in one housing. In some cases, the apparatus further includes a wireless transceiver. The one housing may be a device wearable proximally to the external auditory canal of a person's ear.

In some embodiments, the input and output devices of the apparatus are contained in one housing, such as an ear-bud headphone. The processor may be contained in a housing separate from housing that contains the input and output devices, and can be further configured to receive key information from the input device wirelessly and to provide the related information to the output device wirelessly. Embodiments of the either housing include a wireless device, a laptop, a smartphone, a computer, a server, a mobile device, a tablet computer, and an information storage device.

The input device of the apparatus actively acquires key information, and the types of input devices include a microphone, a camera, a global positioning system (GPS) receiver, a wireless signal receiver, a thermometer, a humidity sensor, and a barometer. The output device of the apparatus provides information related to the key information, and the types of output devices include a visual display device; a speaker; a visible indicator; and a haptic feedback device. The apparatus may further include a processor and a memory, where the processor is configured to communicate with the input device and with the output device. The processor is further configured to access an information source to search for information related to the key information, and to receive the related information found by the search. The processor may be configured to access the information source after only acquiring a threshold quantity of key information. The information source is stored in the memory of the apparatus. The types of information sources include social media data, web page sources, a sales database, a contact database, a weather information system, a health information system, a patient database, news information data, a geographic information system, a geographical database, and a vehicle repair database.

In some cases, the processor of the apparatus is further configured to access another information source to search for other information related to the key information. In one embodiment, the other information source is stored remotely, and the processor is configured to receive the other related information found by the search of the other information source. Once received, the other related information is stored in the memory of the apparatus. Some embodiments of the key information include sounds, electromagnetic radiation, location information, global positioning system (GPS) information, wireless signal information, motion information, ionization radiation, and atmospheric information.

According to some embodiments, the processor is further configured to prepare the key information for search. Thus, in embodiments where the key information includes sounds, the processor is configured to prepare the sounds by using speech recognition to convert the sounds to digital data, such as text. In other embodiments where the key information includes visual information such as images, the processor is configured to prepare the visual information by using pattern recognition to convert the information to digital data, such as a digital image file and/or text. In yet other embodiments, the processor is configured to prepare key information comprising analog information by processing the analog information to digital data.

The information found by the search is provided to the output device. In some embodiments, the input device communicates with the processor via either a wireless connection or a wired connection. In some embodiments, the input device and the output device are housed in one physical device, while in other embodiments, the processor is housed in a device physically separate from the one physical device. Embodiments of the devices include a wireless device, a laptop, a smartphone, a computer, a server, a mobile device, a tablet computer, and an information storage device. According to some embodiments, the input device, the output device, the processor, and the memory are housed in one physical device. In some embodiments, the apparatus further comprises a wireless transceiver. In some of those embodiments, the one physical device comprises a device wearable proximally to the external auditory canal of a person's ear.

According to some embodiments, a method for providing information includes configuring an input device to actively acquire key information, and configuring an output device to provide information related to the key information. Embodiments of the key information include sounds, electromagnetic radiation, location information, global positioning system (GPS) information, wireless signal information, motion information, ionization radiation, and atmospheric information. Embodiments of the input device include a microphone; a camera; a global positioning system (GPS) receiver; a wireless signal receiver; a thermometer; a humidity sensor; and a barometer. Embodiments of the output device include a visual display device; a speaker; a visible indicator; and a haptic feedback device.

In some cases, the method further includes configuring a processor to communicate with the input and output devices, and to access an information source to search for information related to the key information and to receive the related information. Embodiments of information sources include social media data; web page sources; a sales database; a contact database; a weather information system; a health information system; a patient database; news information data; a geographic information system; a geographical database; and a vehicle repair database. In embodiments where the information source is stored remotely, the method further comprises configuring the processor to access the information source via a network connection and to receive the related information via the network connection. Embodiments of the network connection include wired and wireless connections.

The method may further include configuring the processor to prepare the key information for a subsequent search. Thus, in embodiments where the key information comprises sounds, the method comprises configuring the processor to apply speech recognition to the sounds to generate digital data for search. In other embodiments where the key information comprises analog information, the method further comprises configuring the processor to convert the analog information to digital data for search.

In some embodiments, the method further comprises configuring the processor to communicate with the input device and with the output device. The method may include configuring the processor to communicate with the input device via a wireless connection. Likewise, the method may include configuring the processor to communicate with the output device via a wireless connection.

These and other features of the present invention are described in greater detail below in the section titled DETAILED DESCRIPTION.

### BRIEF DESCRIPTION OF THE DRAWING FIGURES

The present invention is described herein with reference to the following drawing figures, with greater emphasis being placed on clarity rather than scale:

FIG. 1 is an illustration of one embodiment of the disclosed subject matter.

FIG. 2 is an in-ear embodiment of the disclosed subject matter.

FIG. 3 is an embodiment having a glasses component and a smartphone component.

FIG. 4 is an embodiment having an in-ear component and a watch component.

FIG. 5 is a flow chart illustration of aspects of the disclosed subject matter.

### DETAILED DESCRIPTION

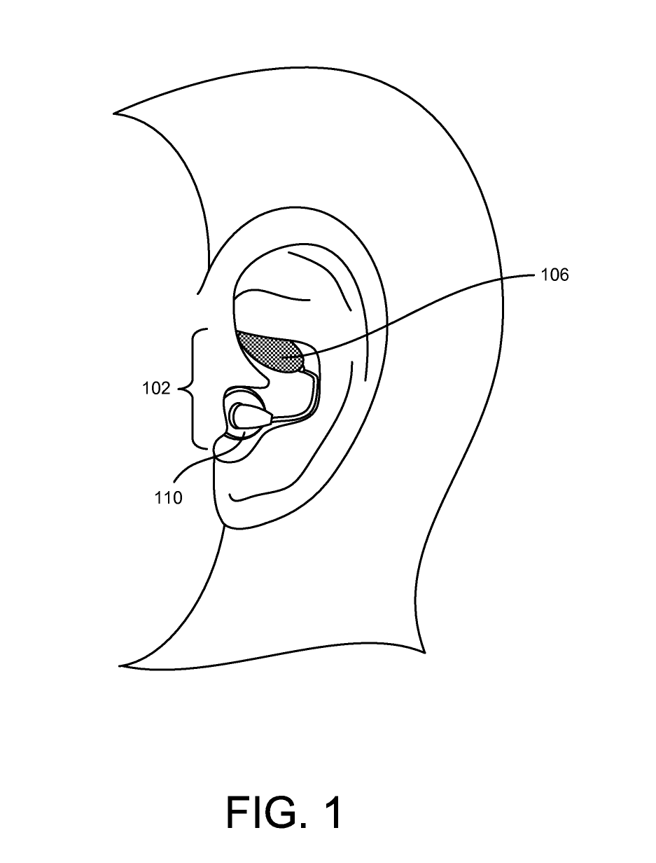

Referring to FIG. 1, an illustration of one embodiment of the disclosed subject matter includes an in-ear apparatus 102, comprising an input device such as a microphone, and an output device 110 such as an ear bud speaker. In this embodiment, the microphone is part of component 106 of the apparatus. Key information, for example, spoken words, is actively acquired by the microphone, and the apparatus 102 accesses and searches information sources, such as social media servers, for information related to the key information.

Although a user may turn the apparatus on or turn, active acquisition means that once the apparatus has been turned on, the user does not need to instruct, request, or command the apparatus to begin or to continue acquisition of the key information. Other terms may be used to describe this aspect of the invention, including passive acquisition or automatic acquisition. Thus, the active acquisition of the key information may be considered passive acquisition, because once the apparatus has been turned on, it acquires the information without the user instructing, requesting, or commanding the apparatus to begin or continue the acquisition. Similarly, the acquisition of the key information may be considered automatic acquisition, because when the apparatus is on, it beings or continues acquiring the key information automatically, without the user instructing, requesting, or commanding the apparatus.

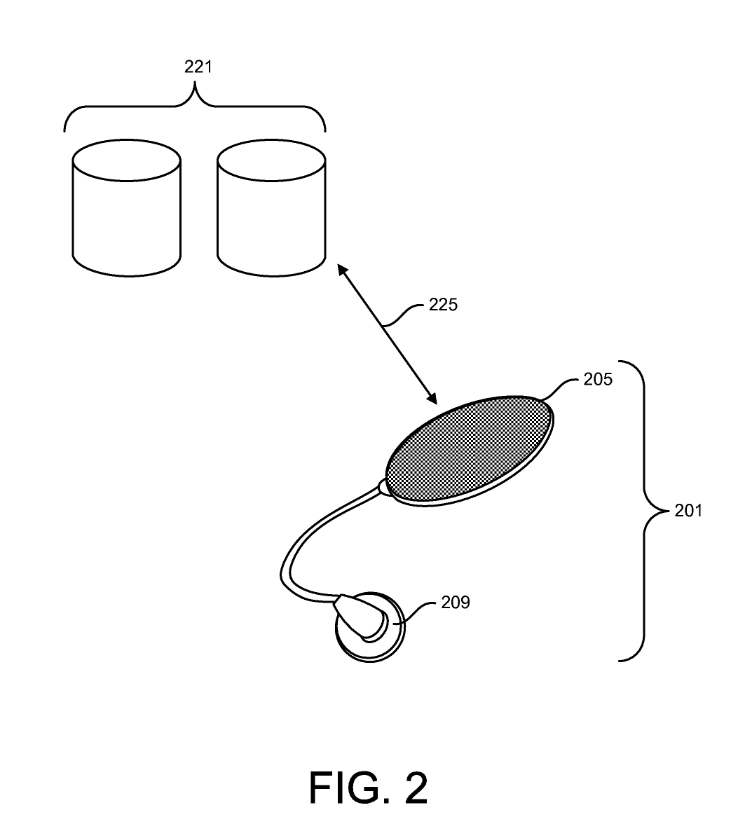

Referring to FIG. 2, in some embodiments, the apparatus 201 actively acquires sounds, such as a person's speech using, for example, a microphone, which in this embodiment is embedded in portion 205 of the apparatus 201. In this embodiment, the apparatus 201 accesses and searches information sources 221 via a wireless connection 225. Because the apparatus 201 actively acquires sounds, a user of the apparatus need not instruct, request, or command the apparatus to acquire, or continue to acquire, the sounds.

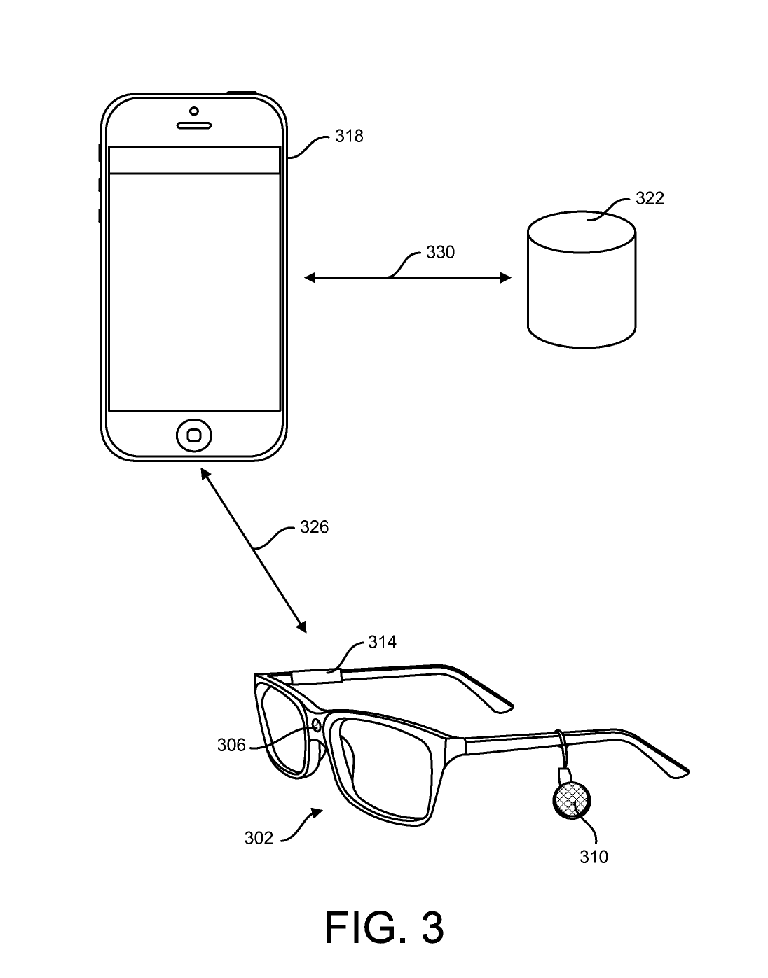

In other embodiments, the apparatus passively acquires visual information, using, e.g., a still camera or a video camera. Referring to FIG. 3, an embodiment of the apparatus includes a wearable component, such as glasses 302, and a processing device 318. Although the processing device 318, in this embodiment, is a smartphone, other embodiments of the processing device 318 include mobile phones, wireless devices, mobile computers, laptop computers, desktop computers, and servers. The wearable component comprises an input device such as a video camera 306, an output device such as an ear-bud speaker 310, and a communications component 314 capable of wireless communications. The smartphone is configured to be in wireless communications 326 with the glasses 302 and to access an information source 322 via wireless communications 330. The information source 322 in this embodiment is located on a remote device, such as a server, but in other embodiments the information source may be located on the processing device 318. The smartphone is further configured to search the information source 322 for information related to the key information. In this embodiment, the information source includes databases that contain information related to the visual information, such as images in a social media database or a police database.

In some embodiments, the active acquisition means that the key information is continuously, or substantially continuously, acquired. In some other embodiments, active acquisition means acquiring the key information at periodic intervals, including at regular periodic intervals. In yet other embodiments, the apparatus automatically acquires key information when conditions are met, for example, only when the key information (such as sounds) is detected, or only when changes to the key information (such as changing visual information) are detected.

Various types of key information may be actively acquired by the disclosed apparatus, including such embodiments as sounds, electromagnetic radiation, location information, global positioning system (GPS) information, wireless signal information, motion information, ionization radiation, and atmospheric information such as temperature, particulate information, gas information, humidity, and pressure. Electromagnetic radiation includes visible light, radio waves, microwaves, infrared light, ultraviolet light, x-rays, and gamma-rays. The different types of input devices necessary to acquire the various embodiments of key information often consists of sensors, and include such embodiments as microphones, cameras, infrared sensors, ultrasound microphones, thermometer, GPS receiver, motion sensor, accelerometer, barometer, Geiger counter, smoke detectors, echo-locators, camera arrays for acquiring 3D information, etc. Other embodiments of key information not expressly recited herein may be actively acquired using other embodiments of input devices, whether or not expressly recited herein, without departing from the scope of this disclosure.

In some embodiments, the key information is processed by the apparatus for use with a subsequent search. In one example, key information comprising sounds is processed to recognize speech using speech recognition techniques. The processing of the sounds produces digital information, such as text, for use with a subsequent search of the information sources. In another example, visual information is processed to recognize patterns, such as objects, persons, text, etc., producing digital information, such as digital images or text, for use with a subsequent search. In some other embodiments, analog information is processed to convert it to digital data for use with a subsequent search.

In some cases, the apparatus is configured to automatically—that is, without any instruction, request, or command from a user—access an information source to search for information related to the key information. The apparatus, for example, may be configured to access the information source as the key information is being acquired. Alternatively, the apparatus may access the information source only after a threshold quantity of the key information has been acquired. The information source that the apparatus accesses may be stored in a memory of the apparatus, in a memory of a remote device, or may be stored partly in the memory of the apparatus and partly in the memory of a remote device.

In another embodiment, the related information found by searching the information sources is provided by the apparatus to a user. Thus, the apparatus, in some embodiments, is configured to automatically retrieve and provide to the output device the related information as it is found by the search. In other embodiments, when related information is found by the search, it is received by the apparatus to automatically provide to the output device. Thus, a user of the apparatus merely needs to turn on the apparatus to enable the apparatus to actively acquire key information, to automatically access and search information sources for information related to the key information, and to automatically retrieve and provide to the user the related information as it is found by the search.

In the example of the in-ear embodiment of FIGS. 1 and 2, a user turns on the apparatus 102, 201, which enables the apparatus to automatically acquire sounds via its microphone without further instruction, request, or command from the user. The sounds may include names of person(s) that may have been spoken in a conversation. The microphone in some embodiments is located in component 106, 205. Once turned on, the apparatus automatically accesses and searches information sources 221 such as social media databases and/or sales information databases for information related to the names of person(s). The apparatus in this embodiment accesses 225 the databases 221 wirelessly. The apparatus also automatically retrieves any information related to the names of persons that was found by the search and to provide that related information to the user via the ear-bud speaker 110, 209.

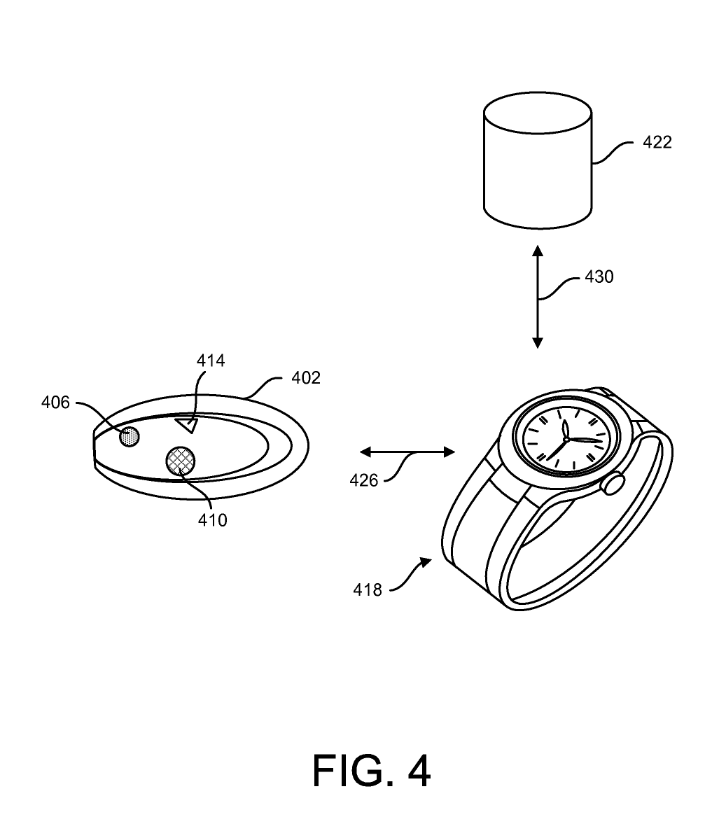

The apparatus may be, in part or in whole, a wearable device, which may be part of a person's wardrobe or accessories. Referring to FIGS. 1 and 2, some embodiments include in-ear pieces 102, 201, over-the-ear headsets, earrings, hair accessories, eyeglasses, and watches. Referring to FIG. 3, the apparatus in some embodiments comprises more than one component, such as eyeglasses 302 in combination with a smartphone 318, or a smartphone in combination with an in-ear piece. Referring to FIG. 4, the apparatus, in some other embodiments, comprises a watch 418 in combination with an in-ear piece 402. The in-ear piece 402 includes a input device microphone 406, an output device speaker 410, and a wireless communication component 414 which communicates wirelessly with watch 418. The watch 418 is configured to wirelessly access the information source 422. Still other embodiments of the apparatus include devices that can be: placed on a person's body or apparel; placed on or in a vehicle, including the vehicle's dashboard; and placed on, at, or near, or affixed to, furniture or an architectural component. Other embodiments may be employed without departing from the scope of those disclosed herein.

The apparatus accesses one or more information sources 221, 322, 422 to search for information related to the key information. Information sources 221, 322, 422 are usually stored on computer readable medium, oftentimes on servers. The types of information sources 221, 322, 422 that the apparatus can access to search for information include social media data; web page sources; a sales database; a contact database; a weather information system; a health information system; a patient database; news information data; a geographic information system; a geographical database; a telephone directory; a dictionary, including foreign language dictionary; a government database; a missing persons database; a sex offender registry; a database of convicts, ex-convicts, and persons sought by the authorities; and a vehicle repair database. Social media data include information from data from LinkedIn, Facebook, and Twitter. Sales databases includes databases related to customers, prospects, potential customers, or former customers, and includes databases associated with commercial sales management software, such as Salesforce.com. Vehicle repair databases include: parts databases and repair procedures information for repair of automobiles, motorcycles, and aircraft. Other embodiments of information sources may be employed without departing from the scope of those disclosed herein.

According to some embodiments, the apparatus provides the related information via an output device. In some cases, the related information is provided via an output device to a user. Referring to FIGS. 1, 2, 3, and 4, embodiments of output devices include: a speaker 110, 209, 310, 410; a visual display device; a visible indicator; a heads-up display; and a haptic feedback device. The output devices perform their common functions—the speaker 110, 209, 310, 410 outputs the related information in audio format. The visual display device comprises a display screen to provide the related information in image or video format. Embodiments of a visible indicator include electrical or electronic means, such as a light or LED that can be turned on and off to provide the related information. Visible indicators also include electromechanical means, such as a mechanical switch, dial, and counter, each configured to provide the related information by indicating a status or message. A heads-up display projects the related information onto a (usually transparent) background. A haptic feedback device outputs forces, vibrations, pressure, or motion, etc. The output device of the apparatus serves to provide related information found by a search, oftentimes to a user. Upon receiving the related information found by a search of information sources, the output device automatically provides the related information, without a user's request, command, or instruction. Other embodiments of the output device may be employed without departing from the scope of those disclosed herein.

In some embodiments of the apparatus, an input device, an output device, and a processing device for accessing the information sources are housed together in a single physical apparatus. In the in-ear apparatus 102, 201 of FIGS. 1 and 2, the input device microphone, the output device ear-bud speaker 110, 209, and the processing device 106, 205 are part of a single physical apparatus. Other embodiments of the apparatus wherein the input device, output device, and processing device are housed in a single physical apparatus include an over-the-ear headset, or a pair of eyeglasses.

In other embodiments of the apparatus, the components of the apparatus may be in separate housings. For example, in FIG. 3, the apparatus comprises a pair of glasses 302 and a smartphone 318. The glasses 302 comprise an input device microphone 306, an output device ear-bud speaker 310, and a wireless communication component 314. The smartphone 318 comprises the processing device, communicates wirelessly 326 with the glasses, and accesses the information source 322 wirelessly 330. In another example, in FIG. 4, the apparatus comprises an in-ear device 402 and a separate watch 418. The in-ear device 402 comprises an input device microphone 406, a output device speaker 410, and a wireless communication component 414. The separate watch 418 comprises the processing device, communicates wirelessly 426 with the in-ear device 402, and accesses an information source 422 wirelessly 430. The wireless communication 225, 326, 330, 426, 430 includes wireless protocols such as Bluetooth, Near Field Communication (NFC), Wi-Fi, cellular, 3G, 4G, HSPA+, WiMAX, LTE, etc.

In yet other embodiments of the apparatus, the input device is housed in one component of the apparatus (for example, an in-car microphone), the output device is housed in a second component (for example, Bluetooth speakers), and the processing device is housed in a third component (for example, a Wi-Fi connected processor such as a smartphone), wherein each device of the apparatus remains in wired or wireless communication with at least one other device. Any of the components may house the processing device that optionally prepares the key information for use with subsequent searches. Other embodiments of the apparatus may be employed without departing from the scope of those disclosed above.

The apparatus can be configured to acquire different types of key information and/or to access alternate information sources. Further, given a type of information source, the apparatus can also be configured to provide certain types of information. For example, the in-ear embodiment 102, 201 may be configured to acquire information by listening for names of persons, to access social media data to search for information related to an acquired name, and to provide via the speaker 110, 209 the related information found by the search. Instead of, or in addition to, accessing social media data, the apparatus may be configured to access a sales information database to search for sales and customer information related to a name of a customer. In another example, the apparatus may be configured to actively listen for locations, such as restaurants and/or addresses, to actively acquire the location of the apparatus via GPS, to search a geographic information database for directions from the location of the apparatus to a restaurant and/or an address, and to provide those directions via the speaker. In some embodiments, the apparatus may be configured by a physical switch on the apparatus to denote which type of key information to acquire or which information source to access. In other embodiments, the apparatus is configured using an application residing in a component of the apparatus, for example, an application residing in a smartphone 318 that is in wired or wireless communications 326 with the glasses component 302.

In some embodiments, the apparatus 102, 201 further comprises a power source, such as a battery, and a switch to power the apparatus on and off. In one embodiment, the switch is a sliding switch, wherein sliding in one direction turns the apparatus on, and sliding in opposite direction turns it off. A person wearing the apparatus may use his finger to slide the switch in the desired direction. When in the powered-on state, the apparatus 102, 201 actively acquires key information without any further instructions, requests, or commands, for example, by actively listening for sounds. The apparatus automatically accesses information resources to search for and retrieve information related to the key information, and automatically provides the found related information via the output device 110, 209. In one feature, the apparatus comprises a mute switch, which turns off only the output device of the apparatus, for example, allowing a user to temporarily disable the audio output.

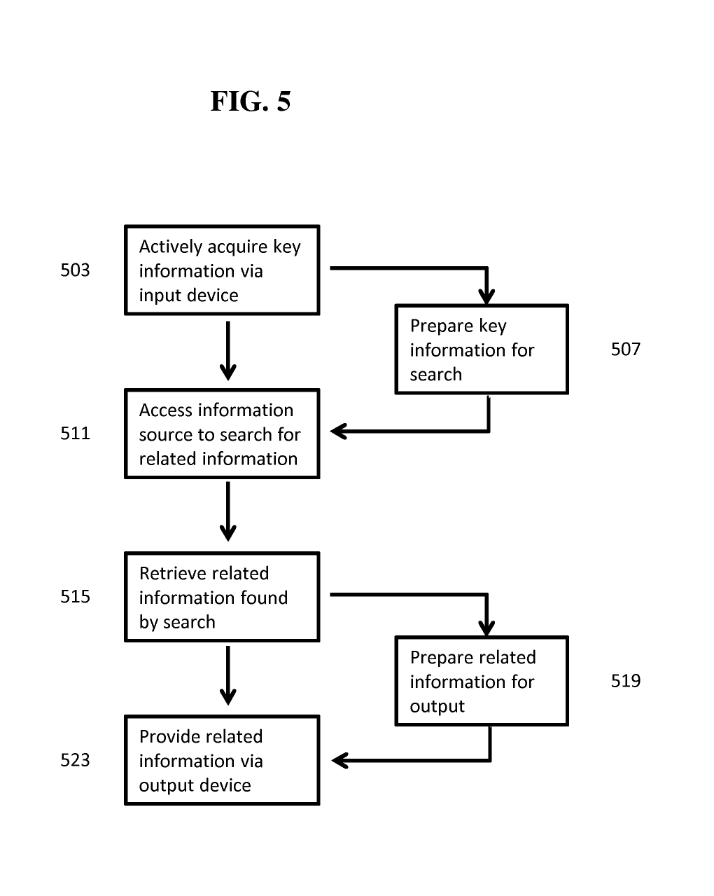

Referring to FIG. 5, the apparatus optionally prepares 507 the key information for use in a subsequent search, for example, by using speech recognition to convert sounds into a digital format, such as text. The apparatus is configurable to search for all of the text, or only names of persons, for example. Whether or not the key information is prepared 507 for search, the apparatus accesses 511 at least one information source to search 511 for information related to the key information, and retrieves 515 the information found by the search. For example, at 511 the apparatus accesses social media data from, for example, the websites of Facebook, LinkedIn, and Twitter, to search for information related to the key information. In that example, the key information may comprise the name of a person and other actively acquired information, and the apparatus searches the social media data for posts by or about the person. The information found by the search is retrieved 515 and provided 523 by the output device of the apparatus, such as a speaker of the in-ear device. So, the apparatus automatically provides a person wearing the in-ear embodiment 102, 201, 402 with information about another person while the two persons are having a conversation. And, in one example, once the in-ear device has been turned on, it actively listens 503 for names of people, optionally prepares 507 the names for search, searches 511 for social media information related to the names, and retrieves 515 and provides 523 the social media information to the user via the in-ear device 102, 201, 402.

Referring to FIG. 5, in some embodiments, after the apparatus retrieves 515 related information found by a search, the apparatus prepares 519 the information found by the search for subsequent output by the output device. In one example, the apparatus includes a camera that actively acquires 503 key information such as images or videos. The apparatus then accesses 511 a database that comprises images of persons sought by law enforcement to search 511 for images in the database that match the acquired images or videos, and to retrieve 515 from the database information related to such matches. The retrieved information may then be prepared 519 for output by the output device 523. In this example, if the retrieved information comprises text information related to the matching image, the apparatus may prepare 519 such text information for output to a speaker 523 by substituting the text with audio representing the text using, for example, speech synthesis. The apparatus is configurable to provide selective output to the output device, for example, to provide only names, events, dates, employers, etc. If the retrieved information comprises images, the apparatus may prepare 519 the images for output by creating an audio description of the image. In either case, the speaker may be part of an in-ear component or otherwise located within earshot of the officer. Thus, without any instruction, request, or command from the officer, the apparatus in that example actively acquires 503 images and videos via a camera, and accesses 511 an information source to search 511 and retrieve 515 matching information such as details related to the acquired images, prepares 519 the retrieved information for output, and provides 523 to the officer audio information about a possible match to persons being sought.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. An apparatus for providing information related to key information, the apparatus comprising:
key information;
an information source;
a processor configured to:
access the information source to search the information source for information related to the key information; and
retrieve the related information; and
a memory for storing the key information and the related information
wherein the key information is actively acquired.

2. The apparatus of claim 1 further comprising:
an input device for acquiring the key information; and
an output device for providing the related information;
wherein, processor is further configured to:
receive the key information from the input device; and
provide the related information to the output device.

3. The apparatus of claim 2 wherein
the key information is selected from a group comprising: sounds, electromagnetic radiation, location information, global positioning system (GPS) information, wireless signal information, motion information, ionization radiation, and atmospheric information;
the input device is selected from a group comprising: a microphone; a camera; a global positioning system (GPS) receiver; a wireless signal receiver; a thermometer; a humidity sensor; and a barometer;
the output device is selected from a group comprising: a visual display device; a speaker; a visible indicator; and a haptic feedback device; and
the information source is selected from a group comprising: social media data; web page sources; a sales database; a contact database; a weather information system; a health information system; a patient database; news information data; a geographic information system; a geographical database; and a vehicle repair database.

4. The apparatus of claim 3 wherein the information source is stored remotely from the processor.

5. The apparatus of claim 3 wherein the information source is stored in the memory.

6. The apparatus of claim 5 wherein the processor is further configured to:
access another information source to search for other information related to the key information; and
retrieve the other related information;
wherein the other information source is stored remotely from the processor.

7. The apparatus of claim 4 wherein the processor accesses the information source via a wired connection.

8. The apparatus of claim 4 wherein the processor accesses the information source via a wireless connection.

9. The apparatus of claim 4 wherein the processor is further configured to prepare the key information for search.

10. The apparatus of claim 9 wherein the key information comprises sounds, and the key information is prepared by applying speech recognition to the sounds.

11. The apparatus of claim 9 wherein the key information comprises visual information, and the processor is configured to prepare the visual information by applying pattern recognition to the visual information.

12. The apparatus of claim 9 wherein the key information is analog information, and the processor is configured to prepare the analog information by converting the analog information to digital data.

13. The apparatus of claim 3 wherein the input device and output device are contained in one housing.

14. The apparatus of claim 13 wherein the processor is further configured to:
receive the key information from the input device wirelessly; and
provide the related information to the output device wirelessly.

15. The apparatus of claim 14 wherein the processor is contained in a housing separate from the one housing.

16. The apparatus of claim 15 wherein the housing separate from the one housing is selected from a group comprising: a wireless device, a laptop, a smartphone, a computer, a server, a mobile device, a tablet computer, and an information storage device.

17. The apparatus of claim 3 wherein the input device, the output device, the processor, and the memory are contained in one housing.

18. The apparatus of claim 17 further comprising a wireless transceiver.

19. The apparatus of claim 18 wherein the one housing comprises a device wearable proximally to the external auditory canal of a person's ear.

20. An apparatus for providing information related to key information, the apparatus comprising:
an input device to actively acquire key information;
an output device to provide information related to the key information; and
a processor in communication with the input device and with the output device.

21. The apparatus of claim 20 wherein the input device is selected from a group comprising: a microphone; a camera; a global positioning system (GPS) receiver; a wireless signal receiver; a thermometer; a humidity sensor; and a barometer.

22. The apparatus of claim 20 wherein the output device is selected from a group comprising: a visual display device; a speaker; a visible indicator; and a haptic feedback device.

23. The apparatus of claim 20 further comprising:
a memory,
wherein the processor is configured to:
access an information source to search for information related to the key information; and
receive the related information found by the search; and
wherein the information source is stored in the memory.

24. The apparatus of claim 23 wherein the information source is selected from a group comprising: social media data; web page sources; a sales database; a contact database; a weather information system; a health information system; a patient database; news information data; a geographic information system; a geographical database; and a vehicle repair database.

25. The apparatus of claim 23 wherein the processor is further configured to:
access another information source to search for other information related to the key information; and
receive the other related information found by the search of the other information source;
wherein the other information source is stored remotely.

26. The apparatus of claim 23 wherein the related information is stored in the memory, and the information source is stored remotely.

27. The apparatus of claim 23 wherein the key information is selected from a group comprising: sounds, electromagnetic radiation, location information, global positioning system (GPS) information, wireless signal information, motion information, ionization radiation, and atmospheric information.

28. The apparatus of claim 23 wherein the processor is further configured to prepare the key information for search.

29. The apparatus of claim 28 wherein the key information comprises sounds, and the processor is further configured to prepare the sounds for search by applying speech recognition to the sounds.

30. The apparatus of claim 28 wherein the key information comprises visual information, and the processor is further configured to prepare the visual information for search by applying pattern recognition to the visual information.

31. The apparatus of claim 28 wherein the key information is analog information, and the processor is further configured to prepare the analog information for search by converting the analog information to digital data.

32. The apparatus of claim 23 wherein the processor is further configured to access the information source after only acquiring a threshold quantity of key information.

33. The apparatus of claim 23 wherein the information found by the search is provided to the output device.

34. The apparatus of claim 23 wherein the input device communicates with the processor via a wireless connection.

35. The apparatus of claim 34 wherein the output device communicates with the processor via a wireless connection.

36. The apparatus of claim 35 wherein the input device and output device are housed in one physical device.

37. The apparatus of claim 36 wherein the processor is located in a device separate from the one physical device.

38. The apparatus of claim 37 wherein the device separate from the one physical device is selected from a group comprising: a wireless device, a laptop, a smartphone, a computer, a server, a mobile device, a tablet computer, and an information storage device.

39. The apparatus of claim 23 wherein the input device, the output device, the processor, and the memory are housed in one physical device.

40. The apparatus of claim 39 further comprising a wireless transceiver.

41. The apparatus of claim 40 wherein the one physical device comprises a device wearable proximally to the external auditory canal of a person's ear.

42. A method for providing information, the method comprising:
providing an input device;
providing an output device;
providing a processor;
configuring the input device to actively acquire key information;
configuring the output device to provide information related to the key information; and
configuring the processor to communicate with the input device and with the output device.

43. The method of claim 42 wherein
the key information is selected from a group comprising: sounds, electromagnetic radiation, location information, global positioning system (GPS) information, wireless signal information, motion information, ionization radiation, and atmospheric information;
the input device is selected from a group comprising: a microphone; a camera; a global positioning system (GPS) receiver; a wireless signal receiver; a thermometer; a humidity sensor; and a barometer; and
the output device is selected from a group comprising: a visual display device; a speaker; a visible indicator; and a haptic feedback device.

44. The method of claim 43 further comprising:
providing a processor;
providing an information source; and
configuring the processor:
to access the information source to search for information related to the key information; and
to receive the related information;
wherein the information source is selected from a group comprising: social media data; web page sources; a sales database; a contact database; a weather information system; a health information system; a patient database; news information data; a geographic information system; a geographical database; and a vehicle repair database.

45. The method of claim 44 further comprising:
providing a network connection; and
configuring the processor:
to access the information source via the network connection; and
to receive the related information via the network connection;
wherein the information source is stored remotely.

46. The method of claim 45, wherein the network connection is a wired connection.

47. The method of claim 45, wherein the network connection is a wireless connection.

48. The method of claim 45 further comprising configuring the processor to prepare the key information for search.

49. The method of claim 48, wherein the key information comprises sounds, the method further comprising configuring the processor to apply speech recognition to the sounds to prepare them for search.

50. The method of claim 48, wherein the key information comprises analog information, the method further comprising configuring the processor to convert the analog information to digital data to prepare the analog information for search.

51. The method of claim 44 further comprising configuring the processor to communicate with the input device via a wireless connection.

52. The method of claim 44 further comprising configuring the processor to communicate with the output device via a wireless connection.
